(19) United States
(12) Patent Application Publication
(10) Pub. No.: US 2026/0214164 A1
(43) Pub. Date: Jul. 23, 2026

(54) SYSTEMS, DEVICES, AND METHODS FOR PHONE CALL MANAGEMENT USING ARTIFICIAL INTELLIGENCE PROCESSES

(71) Applicant: Infinitus Systems, Inc., San Francisco, CA (US)

(72) Inventors: Ankit JAIN, San Francisco, CA (US); Shyamsundar RAJAGOPALAN, San Jose, CA (US); Manas Ajit PALDHE, San Francisco, CA (US); Arushi RAGHUVANSHI, San Francisco, CA (US); Mythri NAGARAJU, Fremont, CA (US)

(21) Appl. No.: 19/442,377

(22) Filed: Jan. 7, 2026

Related U.S. Application Data
(60) Provisional application No. 63/747,757, filed on Jan. 21, 2025.

(51) Int. Cl. H04M 3/42; G10L 15/22

(52) U.S. Cl. CPC H04M 3/4217; G10L 15/22

(57) ABSTRACT

Systems, architectures, and techniques to safely and reliably automate communications using Large Language Models (LLMs) are disclosed. For example, a system may receive an input audio signal and may perform operations that associate the input audio signal with a corresponding position within a predefined conversation flow. Based on an application of one or more guardrails to a set of predefined actions associated with the corresponding position, the system may determine one or more allowable actions associated with the corresponding position, and may select a next action from the one or more allowable actions based on an application of a trained artificial intelligence process to data characterizing the input signal and to data characterizing the one or more allowable actions. The system may also transmit an output audio signal representative of the selected next action to a device.

### CROSS-REFERENCE TO RELATED APPLICATION

This application claims the benefit of priority under 35 U.S.C. § 119(e) to prior U.S. Application No. 63/747,757, filed January 21, 2025, the disclosure of which is incorporated by reference herein to its entirety.

### TECHNICAL FIELD

The disclosed embodiments generally relate to systems, architectures, and computer-implemented processes that automate safely and reliably phone calls using large-language models.

### BACKGROUND

Many organizations and industries leverage automated telephony systems to manage customer service, billing, technical support, and other consumer-facing tasks. Such automated telephony systems utilize many techniques to automate phone calls with limited human input, including autodialing, natural language processing, and voice recognition powered by trained machine-learning or artificial processes.

### BRIEF DESCRIPTION OF DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram of an example environment for automating phone calls using large language models (LLMs).

FIG. 2 is a flow diagram of an example approach to safely and reliably automate phone calls using large language models (LLMs).

FIG. 3 is a flow diagram of an example use case of an example approach to safely and reliably automate phone calls using large language models (LLMs).

FIG. 4 is a flow diagram of an example conversation graph for a system to safely and reliably automate phone calls using large language models (LLMs).

FIG. 5 is a flow chart of an example approach to safely and reliably automate phone calls using large language models (LLMs).

FIG. 6 is a flow chart of an alternative example approach to safely and reliably automate phone calls using large language models (LLMs).

FIG. 7 is an example of a system to safely and reliably automate phone calls using large language models (LLMs).

FIG. 8 is a high-level flow diagram of an example approach to safely and reliably automate phone calls using Large Language Models (LLMs).

FIG. 9 is a block diagram that illustrates an example computer system in which or with which an embodiment of the present disclosure may be implemented.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

In some examples, a computer-implemented method includes receiving, using at least one processor, an input audio signal associated with a communication session involving a first party. The computer-implemented method also includes performing operations, using the at least one processor, that associate the input audio signal with a corresponding position within a predefined conversation flow, and based on an application of one or more guardrails to a set of predefined actions associated with the corresponding position, determining, by the at least one processor, one or more allowable actions associated with the corresponding position. The computer-implemented method includes selecting, using the at least one processor, a next action from the one or more allowable actions based on an application of a trained artificial intelligence process to first data characterizing the input signal and to data characterizing the one or more allowable actions. The computer-implemented method includes transmitting, using the at least one processor, an output audio signal representative of the selected next action to a device associated with the first party.

In other examples, a tangible, non-transitory computer-readable medium stores instructions that, when executed by at least one processor, cause the at least one processor to perform a method that includes receiving an input audio signal associated with a communication session involving a first party. The method includes performing operations that associate the input audio signal with a corresponding position within a predefined conversation flow, and based on an application of one or more guardrails to a set of predefined actions associated with the corresponding position, determining one or more allowable actions associated with the corresponding position. The method includes selecting a next action from the one or more allowable actions based on an application of a trained artificial intelligence process to first data characterizing the input audio signal and to data characterizing the one or more allowable actions. The method includes transmitting an output audio signal representative of the selected next action to a device associated with the first party.

Further, in some examples, a system includes a memory storing instructions and at least one processor coupled to the memory. The at least one processor is configured to execute the instructions to receive an input audio signal associated with a communication session involving a first party. The at least one processor is further configured to execute the instructions to perform operations that associate the input audio signal with a corresponding position within a predefined conversation flow, and based on an application of one or more guardrails to a set of predefined actions associated with the corresponding position, determine one or more allowable actions associated with the corresponding position. The at least one processor is further configured to execute the instructions to select a next action from the one or more allowable actions based on an application of a trained artificial intelligence process to at least first data characterizing the input audio signal and to data characterizing the one or more allowable actions. The at least one processor is further configured to execute the instructions to transmit an output audio signal representative of the next action to a device associated with a recipient.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### DETAILED DESCRIPTION

The following description outlines numerous details to thoroughly understand the present disclosure. It will be apparent, however, to one skilled in the art that the present disclosure may be practiced without some of these specific details. In other instances, well-known structures and devices are shown in block diagram form to avoid obscuring the underlying principles of the present disclosure.

As used herein, a “large language model” or “LLM” refers to a type of artificial intelligence (AI) process that, when executed by one or more processors, is designed to understand and generate human-like text based on a deep understanding of language patterns. These LLMs are built using large amounts of text, data and may be trained at various levels including, for example, individual words, phrases, grammar rules, context, or cultural nuances. Further, the terms “component,” “module,” “system,” and the like as used herein are intended to refer to a computer-related entity, either software-executing general-purpose processor, hardware, firmware, or a combination thereof. For example, a “component” may be, but is not limited to, a process running on a processor, a processor, an object, an executable, a thread of execution, a program, or a computer. Further, a “machine-readable medium,” as described herein, may include, but is not limited to, floppy diskettes, optical disks, CD-ROMs (Compact Disc-Read Only Memories), magneto-optical disks, ROMs, RAMs, EPROMs (Erasable Programmable Read Only Memories), EEPROMs (Electrically Erasable Programmable Read Only Memories), magnetic cards, optical cards, flash memory, or other types of media/machine-readable medium suitable for storing machine-executable instructions.

Today, many organizations manage customer service, billing, technical support, and other consumer-facing tasks using automated telephony systems. These existing systems may, in some instances, automate phone calls with limited human input through the implementation of various processes, including, but not limited to, autodialing, natural language processing, and machine-learning-powered or artificial-intelligence-powered voice recognition. For example, these existing systems often deploy LLMs to analyze caller input, generate responses, manage call flow, and communicate with organizational systems based on telephone calls. Although these LLMs may be pretrained using large amounts of textual data characterizing telephone calls conducted during telephone calls during past temporal intervals, these LLMs may be prone to “hallucinate” when processing textual content that deviates from their training data and may generate factually incorrect or nonsensical output data that is inconsistent with standard operating procedures (SOPs) of the corresponding organizations.

In contrast, certain of the exemplary processes described herein may leverage a LLM to extract information characterizing a telephone call involving an organization and may leverage the extracted information to compute deterministically a next action to perform based on the organization’s human-defined SOPs. By way of example, and through a performance of one or more of the exemplary processes described herein may leverage a LLM to extract entities from phone calls (or other text/voice communications) based on text or voice information generated by the phone calls, and may provide the extracted information and/or entities to a “next action computation” logic that is deterministic and predictable (unlike current neural network based AI models) and that chooses one of multiple pre-determined “human” responses. Unlike many existing chatbots or generative AI tools, an output of the exemplary processes described herein is explainable so that errors can be easily identified and fixed, and as described herein, the selection of the next action or response from a predetermined set reduces or eliminates the hallucinations characteristic of many existing, LLM-based processes. When implemented by one or more computing systems of an organization, certain of the exemplary processes described herein may ensure that the organization’s SOPs are correctly followed and that the corresponding output includes no incorrect information, and these exemplary processes may be implemented in addition to, or as an alternate to, may existing LLM-based systems characterized by output textual content that deviates from training data and that is inconsistent with the SOPs of the corresponding organizations.

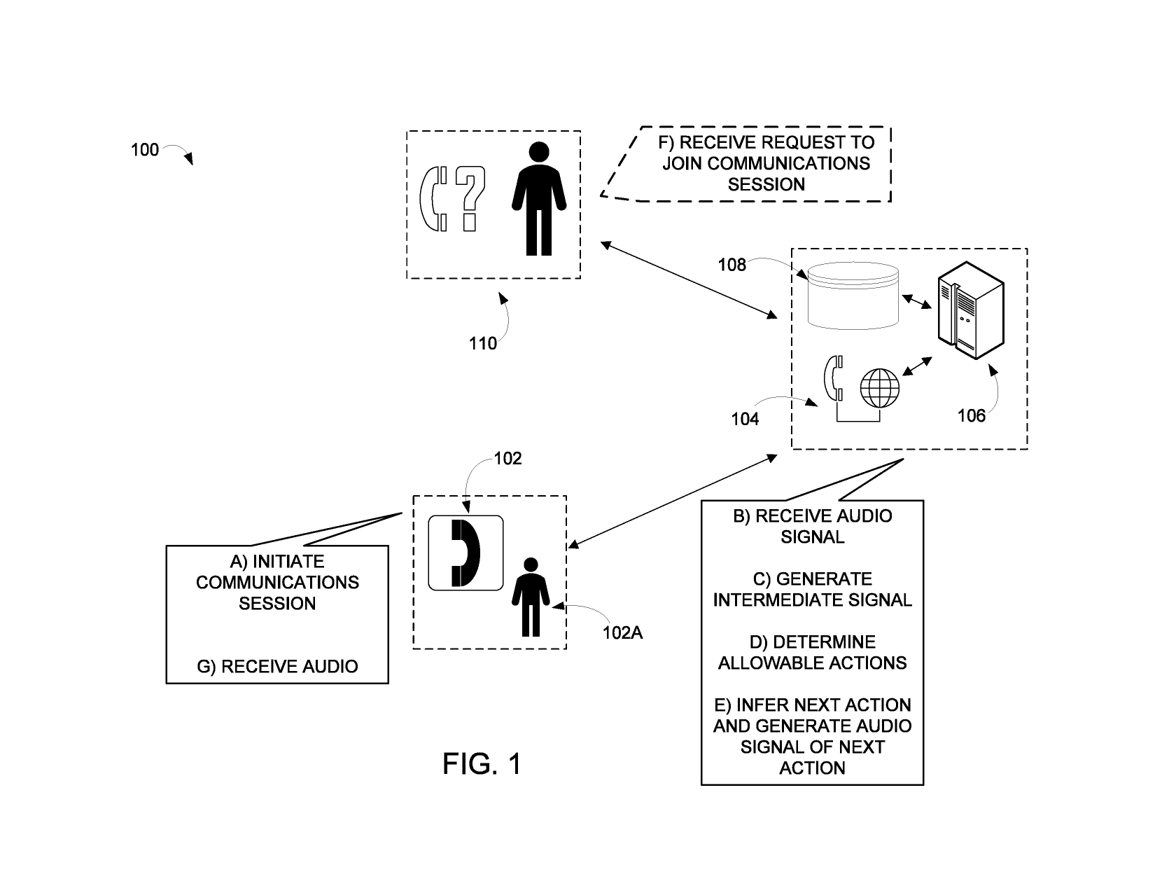

FIG. 1 is a high-level diagram of an example environment 100 for automating phone calls using large language models (LLMs). The environment 100 may represent a deployment or operational environment of the systems, methods, and devices disclosed herein. The environment 100 includes a device 102 associated with a first party such as recipient 102A. The device 102 may be a telephone, a smartphone, a tablet computer, a personal computer, a wearable device, or another device associated with the recipient 102A the recipient 102A may represent a user of the systems, methods, and devices disclosed herein. In some example embodiments, the recipient 102A is a customer or user seeking to call a service hotline of an organization or company. The recipient 102A may be a patient of a medical institution associated with an insurance or healthcare provider.

The device 102 may initiate a communications session with a provider communications interface 104 associated with the organization or institution that the recipient 102A is attempting to contact. The communications session may be a telephone call, a Voice over IP (VoIP) call, an audio call transmitted over the internet, a text communications session, an instant messaging communications session, an email communications session, or another communications session that utilizes a communications interface of the device 102. The communications session between device 102 and provider communications interface 104 operates in real-time or near-real-time. In other example embodiments, the communications session between device 102 and provider communications interface 104 may occur asynchronously.

The provider communications interface 104 is communicatively coupled with a computing system 106. The computing system 106 may be associated with the organization, institution, or other entity that the recipient 102A is attempting to contact. The computing system 106 may correspond to an automated calling system, and in some instances, the computing system 106 may be a computing server, a cloud computing system, or a computing system associated with a third party. The computing system 106 may execute operations that implement the features of the systems, methods, and devices disclosed herein.

In some example configurations, the computing system 106 is communicatively coupled with a database 108. The database 108 includes information associated with the recipient 102A or a product, service, or information to be provisioned to the recipient 102A. The database 108 may be a part of the computing system 106. For example, the database 108 may be one or more storage devices communicatively coupled with and operated by the computing system 106. In other example embodiments, the database 108 may be associated with a third party and communicatively coupled with the computing system 106 via the Internet, a network, or another communications interface.

The provider communications interface 104, the computing system 106, and the database 108 may be communicatively coupled with a call center 110. The call center 110 may be associated with the organization or institution that the recipient 102A is attempting to contact. For example, the call center 110 may be a customer contact center of the organization or institution. The call center 110 may also be associated with a third party. In some example embodiments, the call center 110 includes one or more human operators and one or more devices associated with the one or more human operations that are communicatively coupled with the computing system 106 and/or the provider communications interface 104. In further example embodiments, the human operators of the call center 110 may participate in communications sessions between the recipient devices 102 and the provider communications interface 104 via the computing system 106.

FIG. 1 also describes exemplary operations performed by, and involving, these exemplary components operating within environment 100, e.g., within stages A-F. Each of stages A-F may correspond to one or more of the exemplary operations described herein, and stages A-F do not necessarily represent discrete occurrences over time. The exemplary operations of different stages may overlap in some examples, and the exemplary operations may include greater, fewer, or different operations than those depicted in FIG. 1. Additionally, exemplary stages depicted with dashed lines in FIG. 1 may be optional or otherwise excluded from the operations depicted by stages A-F of FIG. 1.

At stage A, the device 102 of recipient 102A may initiate a communications session with the provider communications interface 104. As explained above, the communications session may be a telephone call, a Voice over IP (VoIP) call, an audio call transmitted over the internet, a text communications session, an instant messaging communications session, an email communications session, or another communications session that utilizes a communications interface of the device 102. The communications session may be transmitted via the provider communications interface 104, which is communicatively coupled with the device 102. For example, the provider communications interface 104 may be an automated phone call system, and the device 102 may communicate with the provider communications interface 104 via a telephone network, a cellular network, or the Internet. The recipient 102A may initiate the communications session via the device 102. For example, the recipient 102A may initiate the communications session via an application executed on the device 102. In other example embodiments, the communications session may be initiated via a hyperlink contained in a web portal executed on the device 102, an email, or another function of the device 102. The communications session may generate audio, video, and/or textual data. Other data may also be transmitted within the communications session.

At stage B, an audio signal is received by the provider communications interface 104. I some example embodiments, other signals, such as signals associated with textual data, video data, or another type of data associated with the device 102, are received by the provider communications interface 104. The audio signal may be transmitted to the computing system 106.

At stage C, an intermediate signal is generated based at least on the audio signal received by the provider communications interface 104. For example, the computing system 106 may generate the intermediate signal based on the audio signal. Generating the intermediate signal may comprise generating a representation of the audio signal that is machine-readable. For example, the computing system 106 may generate a text representation of the audio signal using speech-to-text techniques. The speech-to-text techniques used may include natural language processing (NLP) techniques or the application of a trained machine learning or artificial intelligence process to the audio signal. Generating the intermediate representation may also include generating additional data that indicate tone, speech pace, pause, non-verbal communications markers, and other paralinguistic data associated with the audio signal. The additional paralinguistic data may be encoded into the intermediate representation. In other example embodiments, the intermediate representation includes tokens, text, or other data associated with the additional paralinguistic data. In further example embodiments, the intermediate representation may include metadata that indicates speakers of the speech included in the audio signal, device information of the device 102, location information associated with the device 102 or recipient 102A, or other data generated by the device 102. For example, the recipient 102A may generate information associated with a request, which is encoded into the audio signal or transmitted alongside the audio signal to the provider communications interface 104 and the computing system 106.

At stage D, the computing system 106 may determine allowable actions. A set of allowable actions defines the actions that an AI or LLM-powered automated calling system may take in response to an identified request of the recipient 102A included in the audio signal and the intermediate signal. The set of allowable actions may include specific predefined responses that the AI may take, prompts that are given to the AI to generate a response to the user, or a set of goals and/or tasks given to the AI. In some example embodiments, the set of allowable actions is determined based on one or more AI guardrails. The AI guardrails are predetermined and represent limitations on the actions that the AI may undertake. The AI guardrails may be predetermined by an operator of the computing system 106, or they may be generated by another AI process or operations of the computing system 106.

In some embodiments, determining the set of allowable actions includes applying one or more guardrails that restrict the actions available to the automated calling system at a given stage of the conversation. The guardrails may be implemented as rules associated with states or nodes of a conversation graph, such that only those actions permitted by the guardrails at the current node can be included in the set of allowable actions.

In some example embodiments, determining the set of allowable actions includes processing a graph that represents a conversation flow of the communications session between the recipient 102A and the computing system 106. The graph may include nodes that represent questions or requested information posed by the computing system 106, and the edges may represent responses or inquiries made by the recipient 102A. The computing system 106 may generate the set of allowable actions based on the determined position of the conversation with reference to the graph. In some examples, the graph provides a representation of an intended conversation flow, and the current node of the graph is determined based at least on the intermediate signal and the conversation history of the communications session between recipient 102A and the computing system 106.

At stage E, the computing system 106 may determine an allowable action, for example, by selecting an inferred next action from the set of allowable actions. The inferred next action may be inferred based on an application of a trained machine learning or artificial intelligence process. The trained machine learning or artificial intelligence process may be a neural network, a bag-of-words neural network, or an LLM. The trained machine learning or artificial intelligence network may be configured to generate an intent of the recipient 102A based on the intermediate representation, and to determine an inferred response to the intent of the recipient 102A based on the set of allowable actions. The computing system 106 may compare the inferred next action to the set of allowable actions and the AI guardrails, and if the inferred next action is permitted by the set of allowable actions and the AI guardrails, the computing system 106 may generate an audio signal of the inferred action. Generating the audio signal of the selected next action may include using text-to-speech techniques. In some example embodiments, the computing system 106 may generate the inferred next action based on information received from the database 108. The information may be associated with the recipient 102A or the device 102. For example, the information may be health information associated with the recipient 102A.

At stage F, the computing system 106 may transmit a request to join the communications session to a call center 110. The call center 110 may be associated with the organization that is associated with the computing system 106, or it may be operated by a third party. The call center 110 may include one or more human operators communicatively coupled with the computing system 106 via the provider communications interface 104. In some embodiments of the present disclosure, one or more of the AI guardrails may be violated, and the set of allowable actions may be limited based on the flow of conversation. The computing system 106 may determine that human or other outside intervention may be useful to assist the AI in responding to the requests or responses of the recipient 102A during the communications session. The computing system 106 may determine, as an inferred next action, to request assistance from the call center 110. The computing system 106 may then transmit a request to the call center 110 via the provider communications interface 104, and a human or other outside operator of the call center 110 may join the communications session. In some example embodiments, the call center 110 assumes control of the communications session with the recipient 102A. In other example embodiments, the call center 110 provides guidance to and/or oversight over the actions of the AI of the computing system 106.

At stage G, the audio signal generated by the computing system 106 is received by the device 102. The computing system 106 and/or the device 102 may then perform operations that cause the audio signal to be conveyed to the recipient 102A. The recipient 102A may then use the device 102 to respond to any queries included in the audio signal, or to make further requests for the automated calling system.

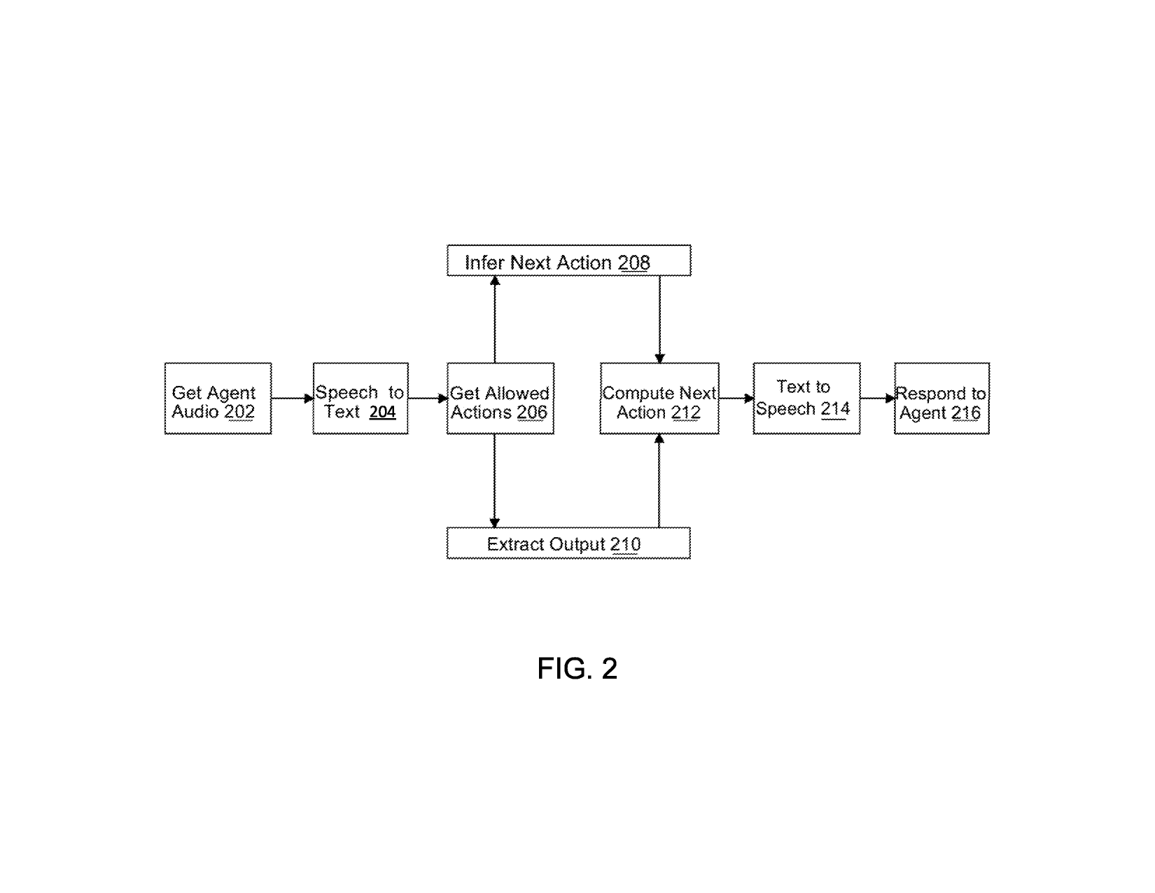

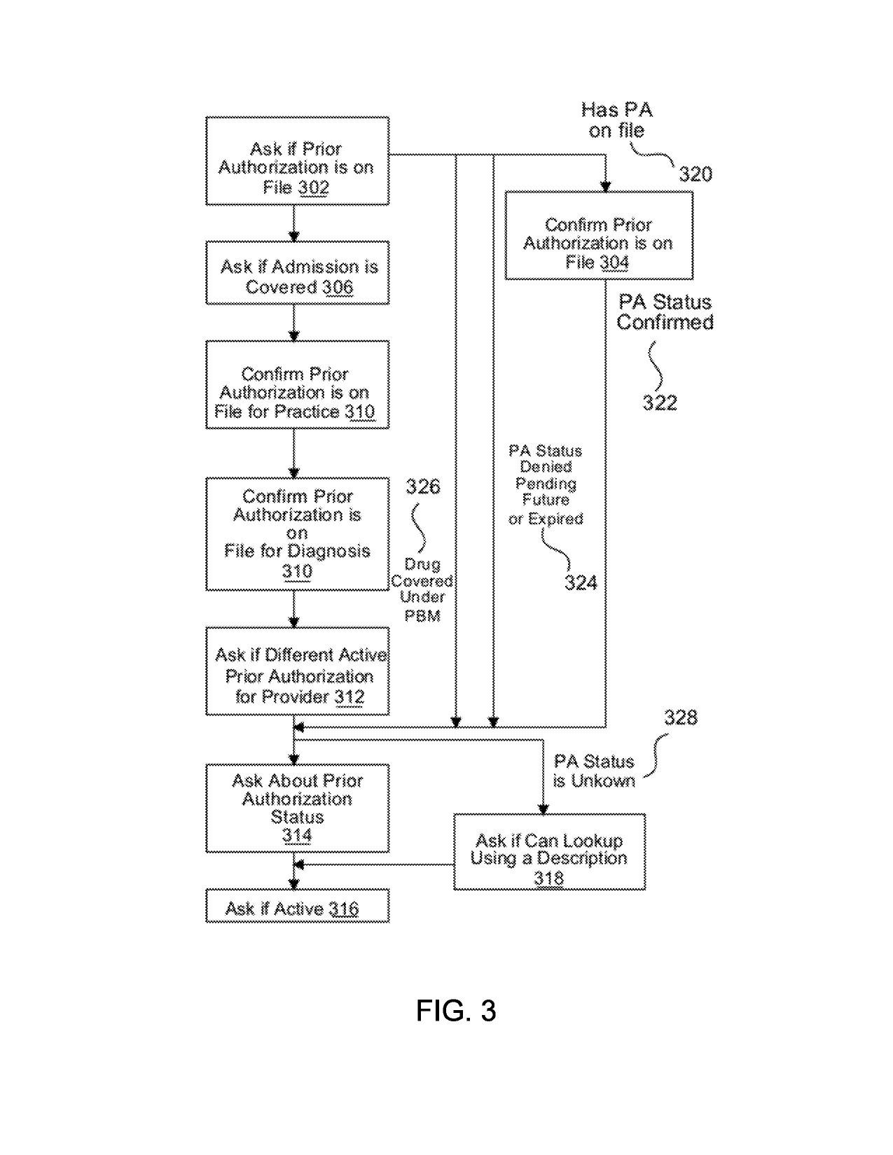

FIG. 2 is a high-level flow diagram of an example approach to safely and reliably automate phone calls using Large Language Models (LLMs). The example of FIG. 2 corresponds to an overall operational flow for communication with an agent over a voice and/or text communication channel (e.g., telephone call), one application of which is illustrated in FIG. 3. The approach illustrated in FIG. 2 can also support other types of calls and or non-telephone call communication channels. For example, the techniques and operations depicted in FIG. 2 may be used to automate conversations automated using an LLM that are performed over text message, video call, audio message, email, or instant message. Further, in some examples, one or more computing systems operating within environment 100, such as the computing system 106, may perform operations at one or more of the blocks of the exemplary approach of FIG. 2.

At block 202, the computing system 106 may receive audio from an agent via a communications channel. In an example, the computing system 106 may perform operations that capture the audio with communication channel logic (e.g., phone call logic) that is configured to monitor (e.g., “listen to”) the communications with the agent and evaluate the conversation according to various parameters (e.g., word recognition, tempo, variations). Technologies for capturing audio signals, such as telephone calls, involve a combination of hardware and software solutions to convert sound waves into electrical or digital signals, process them, and store or transmit the data. For example, a computing system such as computing system 106 may receive the audio via the communications channel. The computing system may include hardware such as digital signal processors (DSPs), graphics processing units (GPUs) and one or more processors configured to receive audio data and process them into digital representations. For example, the one or more processors of the computing system may be configured to convert analog telephone data to a digital representation.

At block 204, the computing system 106 may perform operations that convert the received audio to text. Various text-to-speech technologies can be utilized to provide this functionality. Speech-to-text technology, also known as voice-to-text or automatic speech recognition (ASR), converts spoken language into written text. It is used in applications ranging from virtual assistants to transcription services. Example speech-to-text technologies include Google Cloud Speech-to-Text (which utilizes advanced models like “Chirp,” trained on millions of hours of audio and billions of text sentences); IBM Watson Speech-to-Text (which leverages deep learning and large language models to improve accuracy and handle informal speech patterns); Microsoft Azure Speech-to-Text; etc. In some example embodiments, a natural language processing (NLP) speech-to-text technology is used. In other example embodiments, speech-to-text functionality is implemented through the application of a trained machine learning or artificial intelligence process to the received audio, for example, a neural network.

At block 206, in an example, the computing system 106 may determine allowed actions, e.g., in response to receiving the output of speech-to-text generated at block 204. Limiting actions at this stage provides AI guardrails to reduce or eliminate errors from the AI output(s). In various examples, the computing system 106 may determine the allowed actions through training and/or other mechanisms, including pre-established conversational flows. As illustrated in the example use case of FIG. 2, having contextual information related to the conversation that can be used to curate a list of allowed actions (e.g., responses, inputs, decisions) can be used to provide a more accurate next action (e.g., infer next action at block 208 and/or extract output at block 210). In an example, the list of actions may include computed actions or a combination of computed and human-developed actions. Allowed actions may be limited to a single option or may include a list of allowed actions, depending on the context of the conversation.

At block 212, in an example, the computing system 106 may perform operations that compute the next action, e.g., based on inferred next action computed at block 208, which is constrained by the allowed actions determined at block 206. In some embodiments, the computing system 106 may compute the next action is computed based on (i) the inferred next action, (ii) one or more extracted outputs extracted at block 210, or (iii) any combination of (i)–(ii), with all options constrained by the allowed actions determined at block 206. The choice of which next action to use may be based on the context whether the agent has responded the question posed by the system, or if they are asking us some clarification question. Some examples include: 1) Q: “What is your name?.” The agent may respond: “Manas Paldhe,” in which case the output extracted can be used to compute the next action. Another example is 2) Q: “What is your name?” wherein the agent may respond: “Sorry could you repeat that please?,” in which case the inferred next action is used rather than extracted output. The computing system 106 may convert text matching the computed next action to speech at block 214. Text-to-speech can be accomplished using, for example, the application of a trained machine learning or artificial intelligence process. For example, a neural network may be applied to the text to generate speech. Other NLP techniques may also be used to generate speech from the text. The generated speech is used to respond to the agent via, for example, a telephone at block 216.

FIG. 3 is a flow diagram of an example use case of an example approach to safely and reliably automate phone calls using Large Language Models (LLMs). As noted above, the systems, devices, and methods of the present disclosure may be used to automate phone calls from an individual to their medical provider or medical insurer. The example of FIG. 3 corresponds to a call from a provider to determine whether a prior authorization has been obtained. The example flow of FIG. 3 is a use case corresponding to determining the status of a prior authorization utilizing the approach provided in FIG. 2, and in some instances, one or more computing systems operating within environment 100, such as the computing system 106, may perform operations at one or more of the blocks of the exemplary approach of FIG. 3.

The flow of FIG. 3 illustrates actions taken by the agent managing the communication (e.g., telephone call) with the receiving office (e.g., medical office, medical office representative). After preliminary exchanges to initiate the conversation, the agent can ask if prior authorization (PA) is on file at block 302. At this stage, a limited number of subsequent actions are allowed (e.g., “Has PA on file,” “PA status denied/pending/future/expired,” “Drug covered under PBM”). Other allowed actions may also be included in the set of allowed actions. As discussed above, the limiting of allowed actions may reduce potential errors made during the course of operation of the LLM or AI system automating the call.

In an example, in response to asking if the prior authorization is on file at block 302, and receiving an allowed response (e.g., a confirmation that the office has the requested PA on file, for example at block 320), the computing system 106 may confirm that the PA is on file at block 304, which is one of the allowed actions in the set of allowed actions (e.g., PA status confirmed, shown at element 322). In the example of FIG. 3, other allowed responses can be supported (e.g., PA status denied/pending/future/expired at element 324, Drug covered under PBM at element 326). These are some example responses that are allowed for the use case illustrated in FIG. 3. In other use cases, different allowed responses are supported.

In an example, if no response is received or an unexpected response is received, the computing system 106 may ask if administration is covered at block 306. The computing system 106 may also confirm prior authorization is on file for practice at block 308 and/or confirm prior authorization is on file for diagnosis at block 310 and/or ask if there is a different active prior authorization for provider at block 312. This sequence of inquiries can be adjusted for the specific use case being applied. For example, inquiries about prior authorizations are different from appointment-related activities. Other use cases may be based on different graphs representing an intended conversation flow.

In the example of FIG. 3, after the sequence of inquiries presented above, if the PA status is unknown (for example, at block 328), a branch can be provided to ask if the receiving office can lookup the PA status using a description, shown at block 318. Alternatively, after the sequence of inquiries presented above, if the PA status is known, for example, computing system 106 may ask about a prior authorization status of the recipient at block 314. In an example, the system asks if the prior authorization is active at block 316.

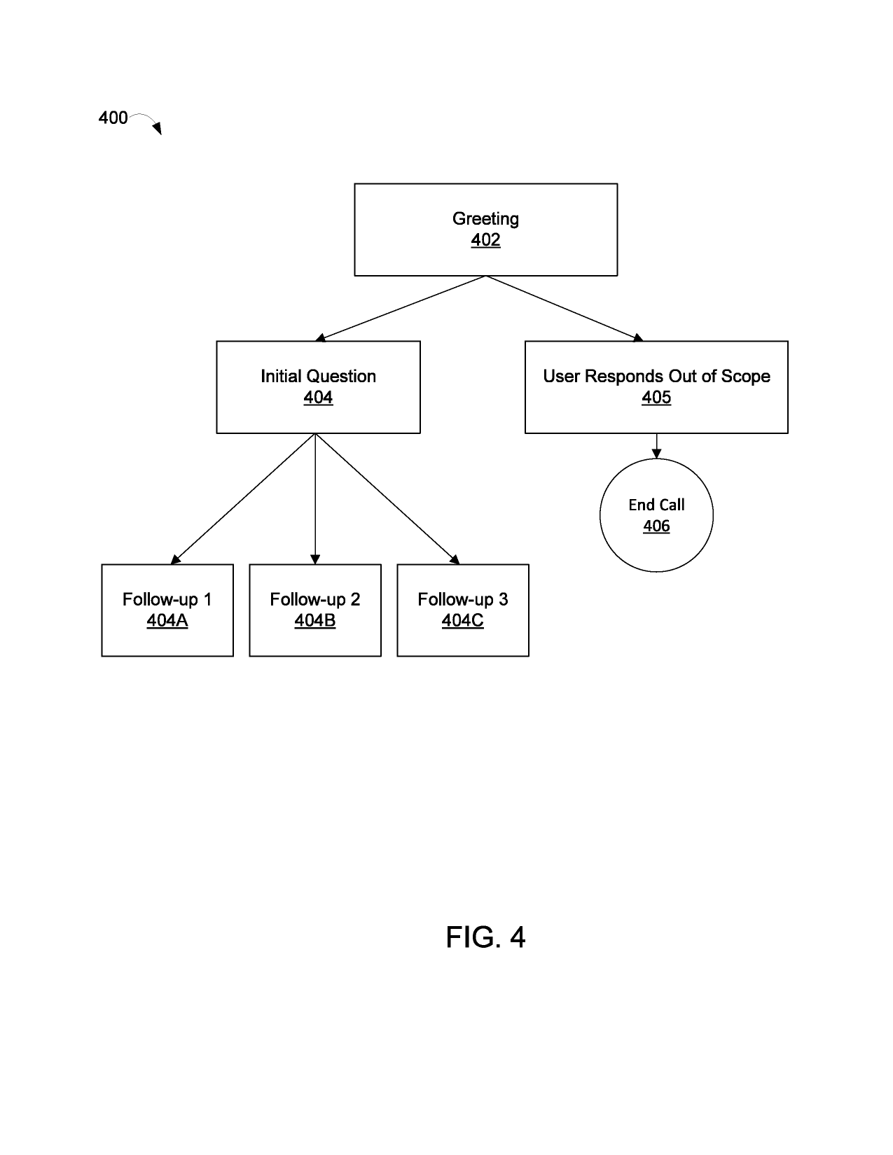

FIG. 4 a flow diagram of an example conversation graph 400 for a system to safely and reliably automate phone calls using large language models (LLMs). The example conversation graph 400 may represent an intended conversation flow between a recipient and an automated calling system, such as, but not limited to, the computing system 106. For example, the example conversation graph 400 may be a generic conversation flow for a customer service request of the recipient to an organization or institution.

The conversation graph 400 may be predetermined by a user or operator of the systems, methods, and devices disclosed herein. For example, various graphs may be determined for various types of conversations that are common to a specific deployment of the systems, devices, and methods disclosed herein. The organization or institution using the automated calling system may establish one or more graphs such as the conversation graph 400 for the automated calling system to utilize. The conversation graph 400 may also be generated by the automated calling system. For example, the conversation graph may be based on prior calls recorded by the automated calling system.

The flow of the conversation begins at block 402. At block 402, the computing system 106 may recite a greeting to the recipient. The greeting may be prerecorded, or it may be generated by an AI system or LLM according to the methods and techniques of the present disclosure. The greeting may be an audio or textual message displayed to the user at a device associated with the user. For example, the greeting may be “Hello, this is Insurance Company X. How may I help you today?” The recipient may respond to this greeting verbally or may select an option or otherwise indicate an intent to continue with the conversation. In some example embodiments, the recipient may respond with an out-of-scope answer or request at block 405. An out-of-scope response may be a response that is unrelated to the capabilities of the automated calling system, or unrelated to the operations of the organization or institution associated with the automated calling system. For example, the recipient could ask an example automated calling system deployed in a healthcare setting “what is my bank account balance?” In this situation, the computing system 106 may determine that it cannot appropriately respond to the recipient’s questions and end the call at block 406. Other actions may be taken by the automated calling system in response to an out-of-scope response.

At block 404, the computing system 106 may perform operations that present an initial question to the recipient. For example, the automated calling system may ask the recipient “Please give me your policy number.” In some examples, the conversation graph 400 includes indicators or other data that require certain information from the recipient to continue the flow of conversation through the conversation graph 400. With reference to the description above, the conversation graph 400 may include an indication that a valid policy number must be given by the recipient to continue the flow of conversation. The recipients’ responses may be validated, processed, or otherwise checked against a data store such as database 208.

At blocks 404A, 404B, and 404C, various follow-up questions such as follow-up 1, follow-up 2, and follow-up 3 may be asked by the computing system 106, e.g., using any of the exemplary processes described herein. Different follow-up questions may be asked based on the answer given by the recipient in response to the initial question of block 404. For example, if the user gives a policy number for policy type A, which further requires a group number, follow-up 1 would be “please state your group number.” Likewise, if the user gives a policy number that has expired, follow-up 2 would be “We’re sorry, but your policy has expired.” In some example embodiments, the system may end the call, or it may transfer control of the call to a human operator.

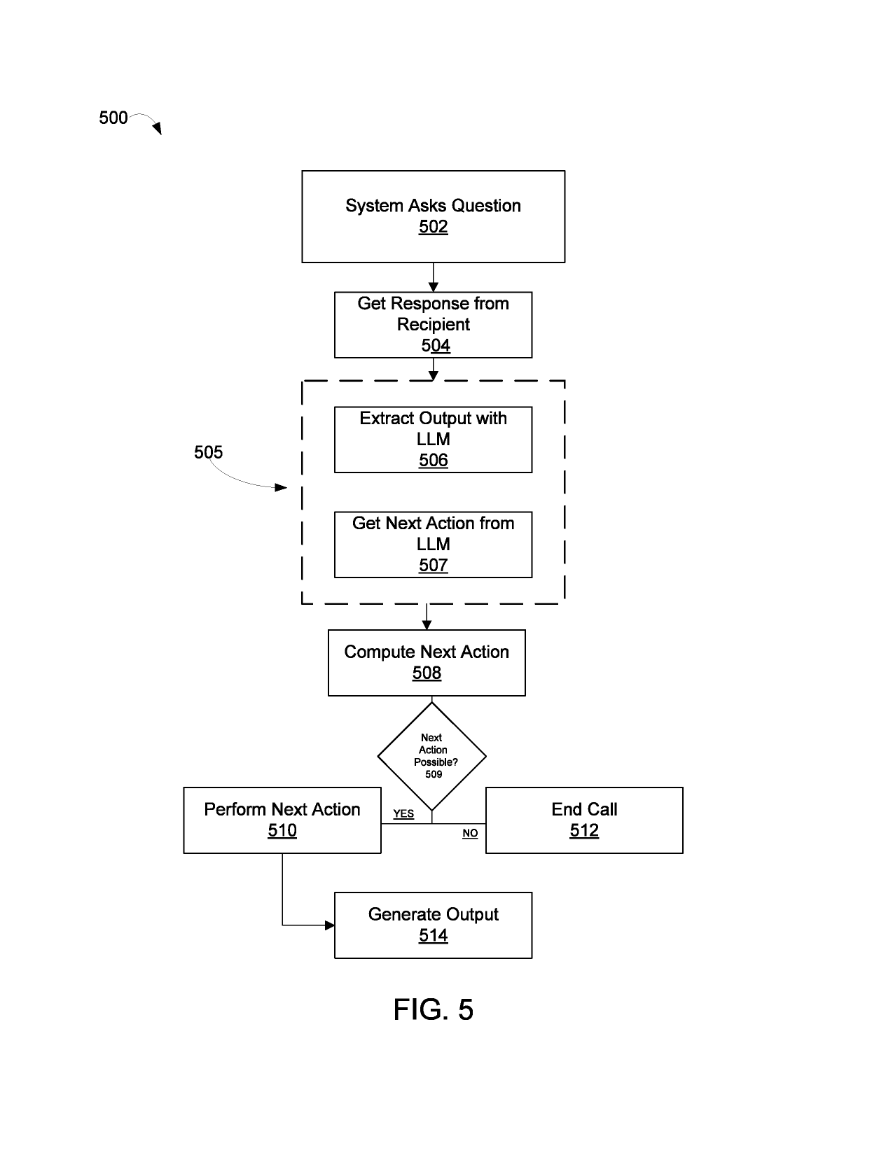

FIG. 5 is a flow chart of an exemplary process 500 to safely and reliably automate phone calls using large language models (LLMs), consistent with some examples. In some instances, one or more computing systems operating within environment 100, such as computing system 106, may perform one or more of the blocks of exemplary process 500, which begins at block 502.

At block 502, the computing system 106 may perform operations that ask a question. The question may be auditorily or textually conveyed to the recipient via a corresponding device, such as device 102, and the question may ask for one or more pieces of information from the recipient. In some examples, the computing system 106 may perform operations, described herein, that generate and leverage a graph, such as the graph depicted in FIG. 4 to determine the flow of conversation. In other examples, the computing system 106 may determine the question using a trained AI process or a LLM that ingests data associated with the recipient and generate a question.

At block 504, the computing system 106 may receive a response from a device associated with, or operable by, the recipient, such as the device 102 operable by the recipient 102A. The response may include information responsive to one or more of the requests included in the question asked at block 502. The response may be transmitted to the automated calling system by the device, and may include additional data, such as attachments, hyperlinks, or other information.

Process 505 of FIG. 5 depicts one or more data ingestion and processing techniques performed or implemented by the computing system 106. At block 506, the computing system 106 may perform operations, described herein, that extract output from the received response. The output may include text, data, and other information associated with the response. In some instances, the computing system 106 may extract the output from the received response using a LLM, which may ingest and analyze text or audio content of the response, and which may extract the output from the response. In some examples, the LLM may also perform operations that determine one or more intents of the response based on the extracted output. For example, the response from the recipient may include “I need to know more about a charge on my policy,” and the LLM may analyze the response and extract “look up policy charges” as an intent of the recipient.

At block 507, one or more next actions may be determined by the LLM. For example, the computing system 106 may provision the text of the response from the recipient as an input to the LLM, with alone or in conjunction with additional information or input. The LLM may, for example, generate one or more responses to the response from the recipient, e.g., based on the ingested text and/or additional information. These one or more responses generated by the LLM may include a potential set of next actions, and the LLM or the computing system 106 may perform operations that determine a proposed next action for the computing system 106.

At block 508, the computing system 106 may perform operations, described herein, that compute the next action of the computing system 106. Computing the next action may include. Among other things, referencing the AI guardrails of the computing system 106. For example, the computing system 106 may determine if the proposed next action generated at block 507 is allowed under the AI guardrails of the system. In some instances, such as when all of the proposed responses violate the AI guardrails, the computing system 106 may determine that no next action is possible, e.g., in block 509. Responsive to determining that no next action is possible (e.g., block 509; NO), the computing system 106 may end the call, shown at block 512. In some examples, the system may elevate the call to a human operator or request other intervention.

Alternatively, if the computing system 106 were to compute a possible next action that complies with the AI guardrails (e.g., block 509; YES), the computing system 106 may perform the next action in block 510. By way of example, the next action may include generating audio output or other output that is transmitted to the recipient, which the computing system 106 may perform at block 514 using any of the exemplary processes described herein. In other examples, the next action may include the computing system 106 performing operations that access a database or other data store associated with the recipient. For example, the computed next action may be a template answer, such as “The amount left on your policy is ____ dollars, due on _____,” and the computing system 106 may utilize an API to access an organizational data store associated with the recipient. In some instances, the computing system 106 may access a database of a health insurance provider of the recipient to access and retrieve the required information, and the computing system 106 may provision the retrieved information as inputs to the LLM, which may integrate the retrieved information into a response to the recipient.

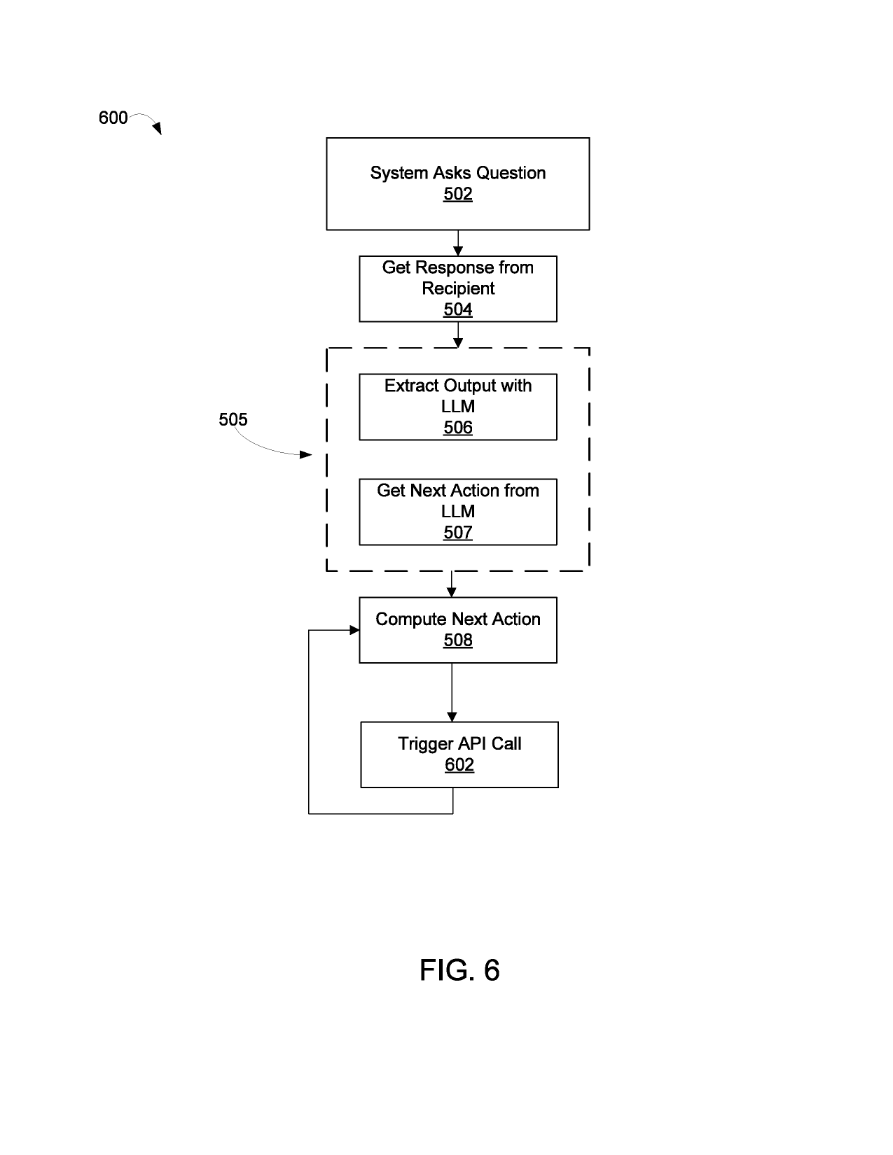

FIG. 6 is a flow chart of an exemplary process 600 to safely and reliably automate phone calls using large language models (LLMs), consistent with some examples. In some instances, one or more computing systems operating within environment 100, such as computing system 106, may perform one or more of the blocks of exemplary process 600. As illustrated in FIG. 6, the flow of example process 600 may be similar to the flow of example process 500 and may include each of blocks 502, 504, 505, 506, 507, and 508 described herein.

Referring to FIG. 6, the computing system 106 may perform any of the exemplary processes described herein to compute an initial next action at block 508. In some instances, the initial next action may trigger the computing system 130 to initiate an API call to an external source of information associated with the user (e.g., in block 602 of FIG. 6), and based the information retrieved from the API, the computing system 106 may compute an additional next action based on the retrieved information associated with the user (e.g., in block 508). For example, the computing system 106 may perform the initial next action computed in block 508, which may first ask the recipient “Could you please share your member ID?,” and the recipient may then respond to the question via device 102, answering “my member ID is 123.” The computing system 130 may receive the response and provision the response as an input to the LLM, which may ingest this input and determine that the computing system 106, or the LLM, needs to lookup the member using their member ID. In some instances, described herein, the operations of the LLM may be based on a conversation graph of the computing system 106. The LLM may trigger a performance of operations by the computing system 106 that initiate an API call to a backend communicatively coupled with a data store associated with the recipient. Through the API call, the computing system 106 may retrieve the information associated with the recipient’s member ID and provision the retrieved information as a further input to the LLM, which may ingest the information associated with the member ID and compute another next action based on the information associated with the member ID using any of the exemplary processes described herein.

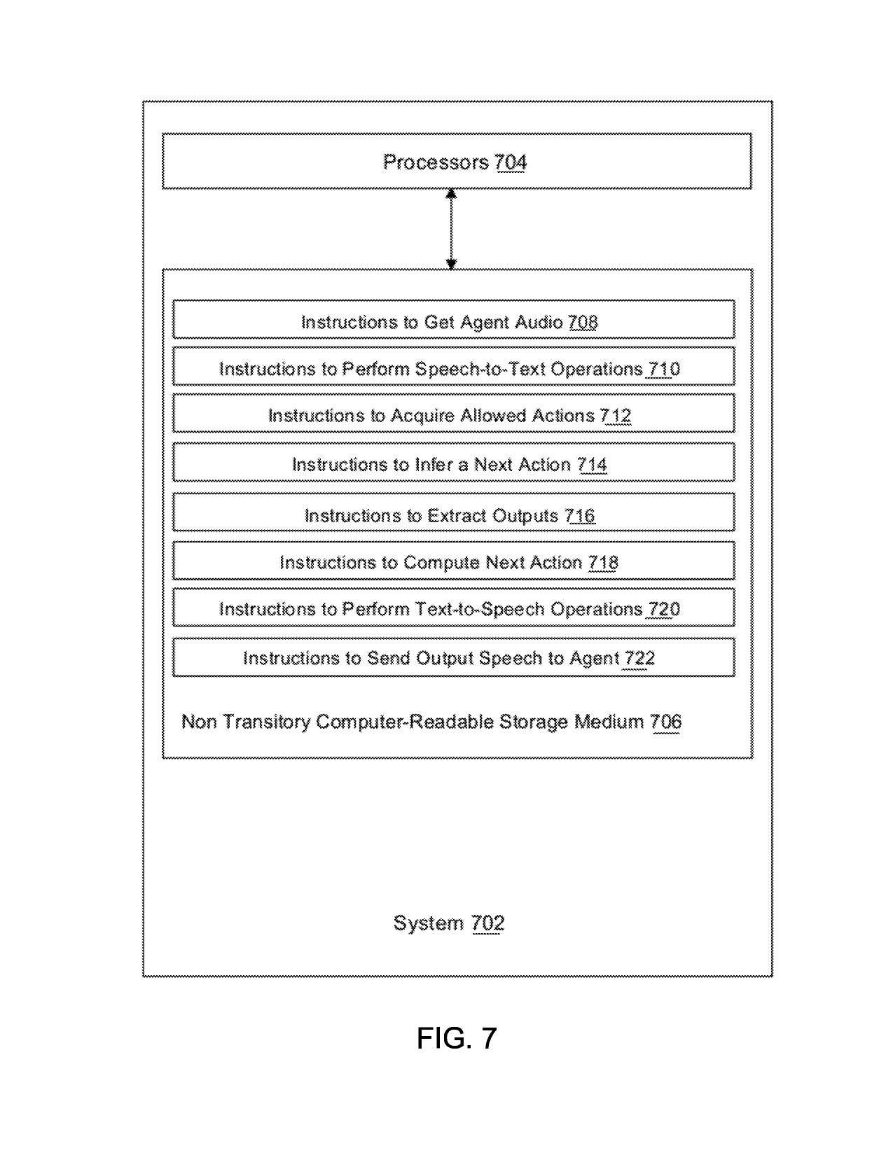

FIG. 7 is an example of a system to safely and reliably automate phone calls using Large Language Models (LLMs). In an example, system 106 may include processor(s) 704 and non-transitory computer-readable storage medium 706. Non-transitory computer-readable storage medium 306 may store instructions 708, 710, 712, 714, 716, 718, 720 and 722 that, when executed by processor(s) 704, cause processor(s) 704 to perform various functions. Examples of processor(s) 704 may include a microcontroller, a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of non-transitory computer-readable storage medium 706 include tangible media such as random-access memory (RAM), read-only memory (ROM), electrically erasable programmable read-only memory (EEPROM), flash memory, a hard disk drive, etc.

Instructions 708 may cause the processor(s) 704 to obtain agent audio. For example, the processor(s) 704 may capture agent audio with communication channel logic (e.g., phone call logic) that is configured to monitor (e.g., “listen”) the communications with the recipient and evaluate the conversation according to various parameters (e.g., word recognition, tempo, variations). In some instances, the processor(s) 704 may determine one or more paralinguistic qualities of the conversation. Paralinguistic qualities may include pauses, voice pitch, nonverbal communication indicators, and other information associated with the conversation. Technologies for capturing audio signals, such as telephone calls, involve a combination of hardware and software solutions to convert sound waves into electrical or digital signals, process them, and store or transmit the data. For example, the processor(s) 704 may execute functions that cause the audio signals to be converted into electrical or digital signals. In other embodiments, the system 702 includes one or more digital signal processors configured to convert the sound waves of the audio signal into electrical or digital signals.

Instructions 710 may cause processor(s) 704 to perform one or more speech-to-text operations. Various text-to-speech technologies can be utilized to provide this functionality. Speech-to-text technology, also known as voice-to-text or automatic speech recognition (ASR), converts spoken language into written text, and executable applications ranging from virtual assistants to transcription services may utilize speech-to-text technologies. Examples of speech-to-text technologies may include, but are not limited to, Google Cloud Speech-to-Text (which utilizes advanced models like “Chirp,” trained on millions of hours of audio and billions of text sentences); IBM Watson Speech-to-Text (which leverages deep learning and large language models to improve accuracy and handle informal speech patterns); Microsoft Azure Speech-to-Text; etc. Other speech-to-text functionalities may be used. For example, the computing system 106 may apply a trained neural network, deep learning model, or other machine learning or artificial intelligence process to the speech data to generate text. In some examples, the artificial intelligence process applied to the speech data is an LLM or a multimodal model.

Instructions 712 may also cause processor(s) 704 to obtain data characterizing allowed actions, which provides guardrails for the overall system operational flow. Limiting actions at this stage provides AI guardrails to reduce or eliminate errors from the AI output(s). In various examples, the allowed actions can be determined through training and/or other mechanisms.

Instructions 714 may also cause processor(s) 704 to perform operations that infer a next action. For example, one or more AI architects can be utilized to infer a next action based on available information (e.g., past inputs, current available next actions, etc.)

Instructions 716 may cause processor(s) 704 to extract outputs. For example, processor(s) 704 may execute instructions 714 and instructions 716 in parallel. In some instances, processor(s) 704 may perform operations, described herein that extract one or more outputs from available information (e.g., the one or more allowable actions, information from speech-to-text, and/or the intermediate signal) based on an application of a trained machine learning or artificial intelligence process.

Instructions 718 may cause processor(s) 704 to compute a next action based on, among other things, (i) the inferred next action, (ii) the one or more extracted outputs, or (iii) any combination of (i)–(ii). Instructions 720 may cause processor(s) 704 to perform text-to-speech operations. For example, processor(s) 704 may determine the text-to-speech output based on the computed next action. Instructions 722 may cause processor(s) 704 to send output speech to the agent.

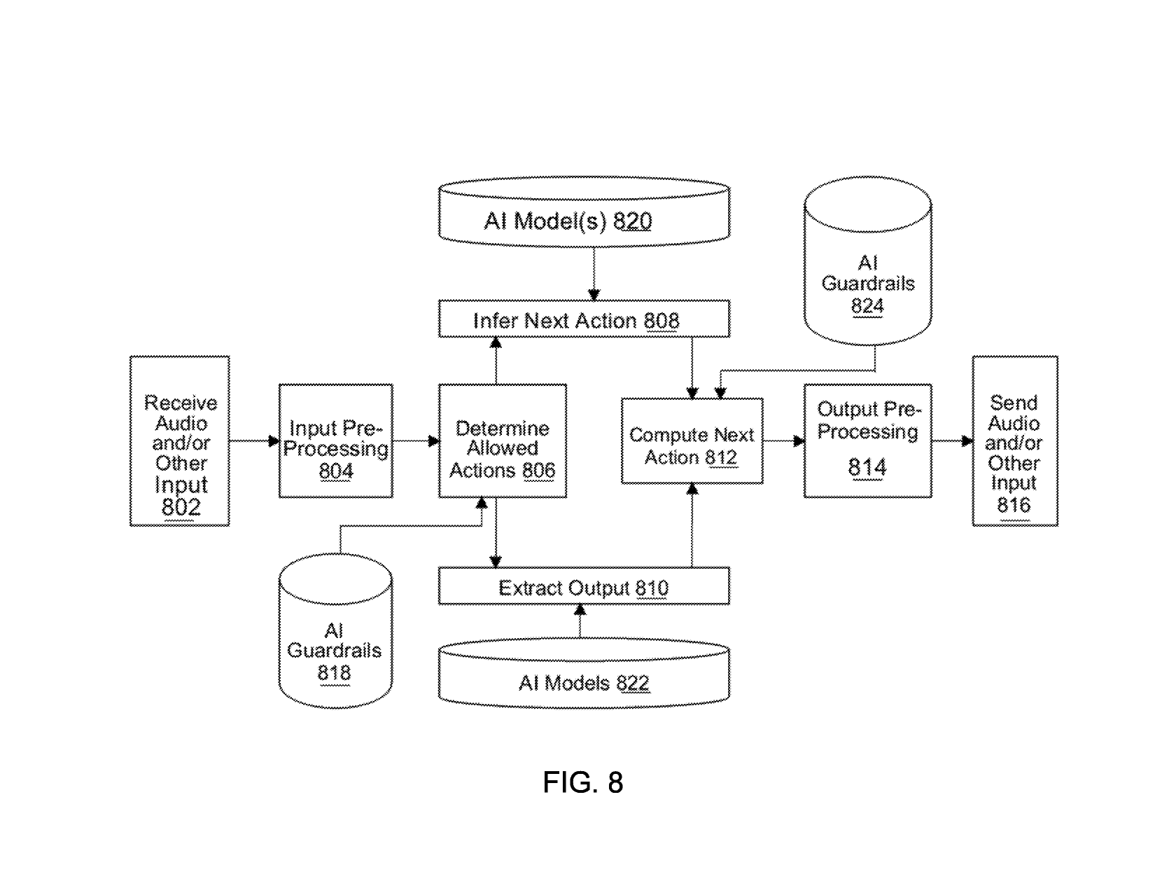

FIG. 8 is a high-level flow diagram of an example approach to safely and reliably automate phone calls using Large Language Models (LLMs). The example of FIG. 5 is applicable to many use cases including, as just one example, the prior authorization processing as described herein.

One or more computing systems operating within environment 100, such as the computing system 106, may receive audio and/or other input at block 802. The audio input can be, for example, from a telephone call or other audio interaction. In an example, the computing system 106 may capture audio with communication channel logic (e.g., phone call logic) that is configured to monitor (e.g., “listen”) the communications with the agent and evaluate the conversation according to various parameters (e.g., word recognition, tempo, variations). Technologies for capturing audio signals, such as telephone calls, involve a combination of hardware and software solutions to convert sound waves into electrical or digital signals, process them, and store or transmit the data. Other types of input (e.g., text, optical, etc.) can be acquired using electronic or electro-optical techniques.

The computing system 106 may perform input pre-processing at block 804 using any of the exemplary processes described herein. In an example, the computing system 106 may convert the received audio to text. Other, non-audio input, can be combined with the audio input during pre-processing. Various text-to-speech technologies can be utilized to provide this functionality. Speech-to-text technology, also known as voice-to-text or automatic speech recognition (ASR), converts spoken language into written text. It is used in applications ranging from virtual assistants to transcription services. Example speech-to-text technologies include Google Cloud Speech-to-Text (which utilizes advanced models like “Chirp,” trained on millions of hours of audio and billions of text sentences); IBM Watson Speech-to-Text (which leverages deep learning and large language models to improve accuracy and handle informal speech patterns); Microsoft Azure Speech-to-Text; etc. Other speech-to-text functionalities may be used. For example, a trained neural network, deep learning model, or other machine learning or artificial intelligence process may be applied to the speech data to generate text. In some examples, the artificial intelligence process applied to the speech data is an LLM or a multimodal model.

In an example, the computing system 106 may perform operations, described herein, to retrieve allowed actions at block 806, e.g., in response to receiving the output of input pre-processing at block 804. In an example, the computing system 106 may utilize AI guardrails at block 818 to limit the available actions and provide additional accuracy when determining the allowed actions at block 806. As described herein, computing system 106 may utilize various AI techniques to determine one or more guardrails to be applied when determining the allowed actions.

Limiting actions at this stage provides AI guardrails to reduce or eliminate errors from the AI output(s). In various examples, the allowed actions can be determined through training and/or other mechanisms. As illustrated in the example use case of FIG. 3, having contextual information related to the conversation that can be used to curate a list of allowed actions (e.g., responses, inputs, decisions) can be used to provide a more accurate next action (e.g., infer next action at block 808 and/or extract output at block 810).

In an example, the computing system 106 may compute the next action at block 812 based on inferred next action inferred at block 808, which is constrained by the allowed actions determined at block 806. Similarly, the computing system 106 may compute the next action at block 812 based on extracted output extracted at block 810, which is constrained by the allowed actions determined at block 806. In an example one or more AI models are used when inferring the next action (e.g., AI model(s) 520) and/or when extracting extract outputs at block 810 (e.g., AI model(s) 522).

The computing system 106 may also perform operations, described herein, that apply one or more AI guardrails (e.g., AI guardrails 824) to the next action and that apply output pre-processing is applied at block 814. In an example, the output pre-processing may include one or more text-to-speech operations and/or providing corresponding non-audio output (e.g., text message, braille output, etc.). The generated output is used to respond to the recipient via, for example, a telephone 816 and/or other devices operable by the recipient, e.g., device 102.

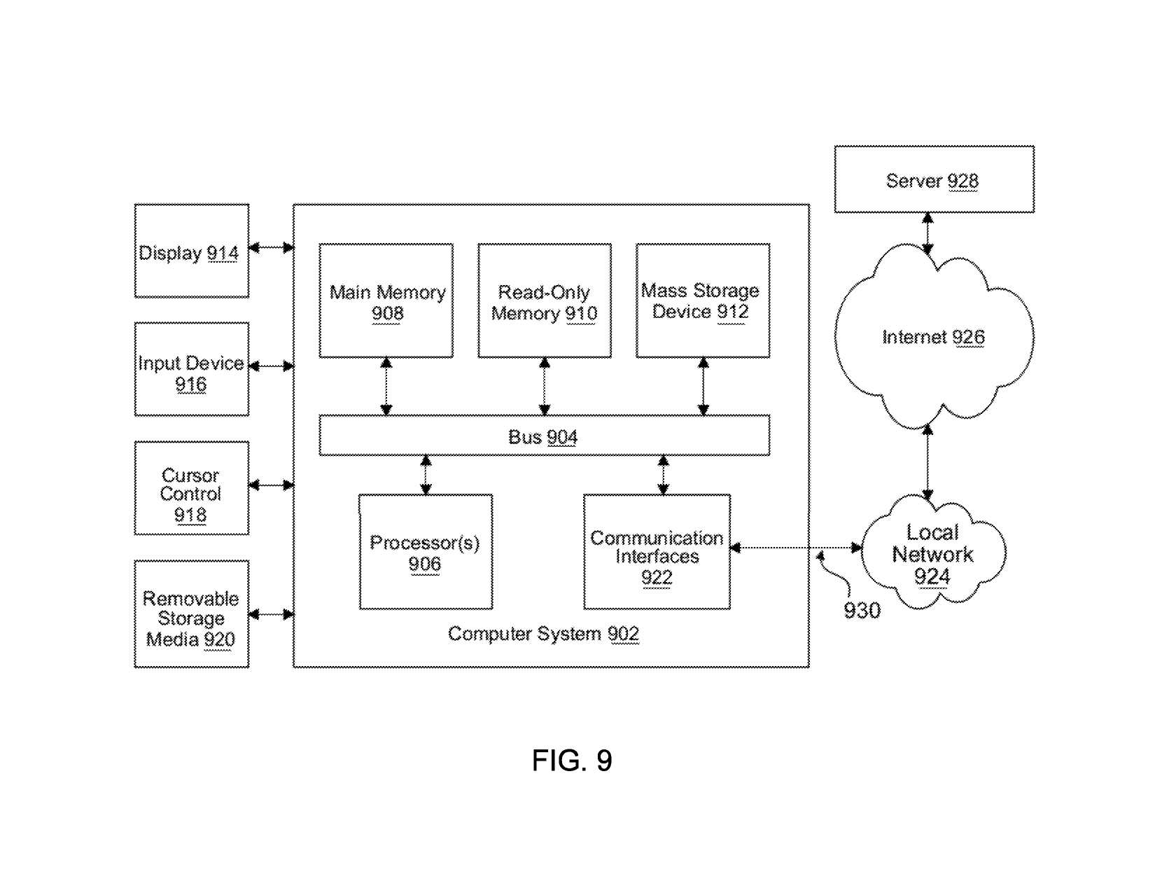

FIG. 9 is a block diagram that illustrates an exemplary computer system in which or with which an embodiment of the present disclosure may be implemented. Computer system 902 may be representative of an endpoint or client device (e.g., one of the off-net clients or on-net clients) on which an endpoint security agent is running and acting as a proxy on behalf of a client application (e.g., a browser). Notably, components of computer system 902 described herein are meant only to exemplify various possibilities, and in no way should example computer system 902 limit the scope of the present disclosure. Examples of computing system 902 may include, but are not limited to, the computing system 106 and/or the device 102.

In the context of the present example, computer system 902 includes bus 904 or other communication mechanism for communicating information and one or more processing resources (e.g., one or more hardware processor(s) 906) coupled with bus 904 for processing information. Hardware processor(s) 906 may include, for example, one or more general-purpose microprocessors available from one or more current or future microprocessor manufacturers (e.g., Intel Corporation, Advanced Micro Devices, Inc., and/or the like) and/or one or more special-purpose processors (e.g., CPs, NPs, and/or accelerators or co-processors). In some examples, one or more processing resources may be part of an ASIC-based security processing unit (e.g., the FORTISP family of security processing units available from Fortinet, Inc. of Sunnyvale, CA).

Computer system 902 also includes main memory 908, such as a random-access memory (RAM) or other dynamic storage device, coupled to bus 904 for storing information and instructions to be executed by processor(s) 906. Main memory 908 also may be used for storing temporary variables or other intermediate information during execution of instructions to be executed by processor(s) 906. Such instructions, when stored in non-transitory storage media accessible to processor(s) 906, render computer system 902 into a special-purpose machine customized to perform the operations specified in the instructions.

Computer system 902 includes a read-only memory 910 or other static storage device coupled to bus 904 for storing static information and instructions for processor(s) 906. Mass storage device 912 (e.g., a magnetic disk, optical disk or flash disk (made of flash memory chips), is provided and coupled to bus 904 for storing information and instructions.

Computer system 902 may be coupled via bus 904 to display 914 (e.g., a cathode ray tube (CRT), Liquid Crystal Display (LCD), Organic Light-Emitting Diode Display (OLED), Digital Light Processing Display (DLP) or the like, for displaying information to a computer user. Input device 916, including alphanumeric and other keys, is coupled to bus 904 for communicating information and command selections to processor(s) 906. Another type of user input device is cursor control 918, such as a mouse, a trackball, a trackpad, or cursor direction keys for communicating direction information and command selections to processor(s) 606 and for controlling cursor movement on display 914. This input device typically has two degrees of freedom in two axes, a first axis (e.g., x) and a second axis (e.g., y), that allows the device to specify positions in a plane.

Removable storage media 920 can be any kind of external storage media, including, but not limited to, hard-drives, floppy drives, IOMEGA® Zip Drives, Compact Disc – Read Only Memory (CD-ROM), Compact Disc – Re-Writable (CD-RW), Digital Video Disk – Read Only Memory (DVD-ROM), USB flash drives and the like.

Computer system 902 may implement the techniques described herein using customized hard-wired logic, one or more ASICs or FPGAs, firmware or program logic which in combination with the computer system causes or programs computer system 902 to be a special-purpose machine. According to one embodiment, the techniques herein are performed by computer system 902 in response to processor(s) 906 executing one or more sequences of one or more instructions contained in main memory 908. Such instructions may be read into main memory 608 from another storage medium, such as mass storage device 612. Execution of the sequences of instructions contained in main memory 908 causes processor(s) 906 to perform the process steps described herein. In alternative embodiments, hard-wired circuitry may be used in place of or in combination with software instructions.

The term “storage media” as used herein refers to any non-transitory media that store data or instructions that cause a machine to operate in a specific fashion. Such storage media may comprise non-volatile media or volatile media. Non-volatile media includes, for example, optical, magnetic, or flash disks, such as mass storage device 912. Volatile media includes dynamic memory, such as main memory 908. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wires, and fiber optics, including the wires that comprise bus 904. Transmission media can also be acoustic or light waves, such as those generated during radio-wave and infrared data communications.

Various forms of media may be involved in carrying one or more sequences of one or more instructions to processor(s) 906 for execution. For example, the instructions may initially be carried on a magnetic disk or solid-state drive of a remote computer. The remote computer can load the instructions into its dynamic memory and send the instructions over a telephone line using a modem. A modem local to computer system 902 can receive the data on the telephone line and use an infrared transmitter to convert the data to an infrared signal. An infra-red detector can receive the data from the infra-red signal, and appropriate circuitry can place the data on bus 904. Bus 904 carries the data to main memory 908, from which processor(s) 906 retrieve and execute the instructions. The instructions received by main memory 908 may optionally be stored on mass storage device 912 either before or after execution by processor(s) 906.

Computer system 902 also includes communication interface(s) 922 coupled to bus 904. Communication interface(s) 922 provides a two-way data communication coupling to network link 930 that is connected to local network 924. For example, communication interface(s) 922 may be an integrated services digital network (ISDN) card, cable modem, satellite modem, or a modem to provide a data communication connection to a corresponding type of telephone line. Another example is communication interface(s) 922 which may be a local area network (LAN) card that provides a data communication connection to a compatible LAN. Wireless links may also be implemented. In any such implementation, communication interface(s) 922 sends and receives electrical, electromagnetic or optical signals that carry digital data streams representing various types of information.

Network link 930 typically provides data communication through one or more networks to other data devices. Local network 924 and internet 926 both use electrical, electromagnetic or optical signals that carry digital data streams. The signals through the various networks and network link 930 and through communication interface(s) 922, which carry the digital data to and from 902, are example forms of transmission media.

Computer system 902 can send messages and receive data, including program code, through the network(s), network link 930 and communication interface(s) 922. In the Internet example, server 928 might transmit a requested code for an application program through local network 924 and communication interface(s) 922. The received code may be executed by processor(s) 906 as it is received or stored in mass storage device 912 or other non-volatile storage for later execution.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term "logic" may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein.

Computer executable components can be stored, for example, on non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device type, in accordance with the claimed subject matter.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Reference in the specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment.

It is contemplated that any number and type of components may be added to and/or removed to facilitate various embodiments including adding, removing, and/or enhancing certain features. For brevity, clarity, and ease of understanding, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

By way of illustration, both an application running on a server and the server can be a component. One or more components may reside within a process and/or thread of execution, and a component may be localized on one computer and/or distributed between two or more computers. Also, these components can execute from various non-transitory, computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

What is claimed is:

1. A computer-implemented method, comprising:
receiving, using at least one processor, an input audio signal associated with a communication session involving a first party;
performing operations, using the at least one processor, that associate the input audio signal with a corresponding position within a predefined conversation flow, and based on an application of one or more guardrails to a set of predefined actions associated with the corresponding position, determining, by the at least one processor, one or more allowable actions associated with the corresponding position;
selecting, using the at least one processor, a next action from the one or more allowable actions based on an application of a trained artificial intelligence process to first data characterizing the input signal and to data characterizing the one or more allowable actions; and
transmitting, using the at least one processor, an output audio signal representative of the selected next action to a device associated with the first party.

2. The computer-implemented method of claim 1, wherein the device associated with the first party is a telephone or smartphone associated with the first party.

3. The computer-implemented method of claim 1, further comprising:
applying, using the at least one processor, a speech recognition process to the audio input signal and paralinguistic data associated with the input audio signal; and
generating, using the at least one processor, an intermediate signal that includes first text data based on the application of a speech recognition process to the input audio signal and the paralinguistic data.

4. The computer-implemented method of claim 1, wherein the input audio signal is associated with an audio call from the device associated with the first party.

5. The computer-implemented method of claim 1, wherein the first data characterizing the input audio signal includes textual data.

6. The computer-implemented method of claim 1, further comprising:
obtaining, using the at least one processor, second data characterizing the input audio signal; and
based on the second data, generating, using the at least one processor, paralinguistic data associated with one or more paralinguistic indicators associated with the input audio signal.

7. The computer-implemented method of claim 1, wherein the set of predefined actions corresponds to a human-defined standard operating procedure for the predefined conversation flow.

8. The computer-implemented method of claim 1, wherein:
the operations that associate the input audio signal with the corresponding position comprise:
establishing, by the one or more processors, a graph representation of the predefined conversation flow; and
determining, by the one or more processors, and based on the first data, a node of the graph representation associated with the corresponding position within the predefined conversation flow; and
the set of predefined actions are associated with the determined node of the graph representation.

9. The computer-implemented method of claim 1, wherein the selecting comprises:
generating output data based on the application of the trained artificial intelligence process, the output data characterizing a caller intent for the input signal;
generating a response intent for each of the one or more allowable actions; and
performing operations that infer the next action based on at least the caller intent and each response intent of the one or more allowable actions.

10. The computer-implemented method of claim 9, wherein each response intent for each of the one or more allowable actions is generated based on the application of an additional trained artificial intelligence process to at least the first data characterizing the input audio signal and the one or more allowable actions.

11. The computer-implemented method of claim 1, further comprising training, using the at least one processor, the artificial intelligence process using domain-specific conversational data associated with a particular conversational workflow.

12. The computer-implemented method of claim 1, further comprising:
based on at least the one or more allowable actions and the one or more guardrails, determining, using the at least one processor, that the next action is insufficient to respond to the input audio signal; and
transmitting, using the at least one processor, the input signal to an additional device associated with an operator.

13. A tangible, non-transitory computer-readable medium storing instructions that, when executed by at least one processor, cause the at least one processor to perform a method, comprising:
receiving an input audio signal associated with a communication session involving a first party;
performing operations that associate the input audio signal with a corresponding position within a predefined conversation flow, and based on an application of one or more guardrails to a set of predefined actions associated with the corresponding position, determining one or more allowable actions associated with the corresponding position;
selecting a next action from the one or more allowable actions based on an application of a trained artificial intelligence process to first data characterizing the input audio signal and to data characterizing the one or more allowable actions; and
transmitting an output audio signal representative of the selected next action to a device associated with the first party.

14. A system, comprising:
a memory storing instructions; and
at least one processor coupled to the memory, the at least one processor being configured to execute the instructions to:
receive an input audio signal associated with a communication session involving a first party;
perform operations that associate the input audio signal with a corresponding position within a predefined conversation flow, and based on an application of one or more guardrails to a set of predefined actions associated with the corresponding position, determine one or more allowable actions associated with the corresponding position;
select a next action from the one or more allowable actions based on an application of a trained artificial intelligence process to at least first data characterizing the input audio signal and to data characterizing the one or more allowable actions; and
transmit an output audio signal representative of the next action to a device associated with a recipient.

15. The system of claim 14, wherein the device associated with a recipient is a telephone or smartphone associated with the recipient.

16. The system of claim 14, wherein the device associated with the recipient is communicatively coupled with the one or more processors via an automated audio call interface comprising at least one of: a cellular telephony interface, PSTN interface, SIP interface, VoIP interface, or WebRTC-based audio channel.

17. The system of claim 14, wherein:
the system further comprises a communications interface coupled to the at least one processor; and
the at least one processor is further configured to execute the instructions to:
receive, via a communications interface, additional data associated with the first party from a database of an organization; and
select, by the one or more processors, the next action from the one or more allowable actions based on an application of a trained artificial intelligence process to the first data characterizing the input signal, the data characterizing the one or more allowable actions, and the additional data associated with the recipient.

18. The system of claim 17, wherein the at least one processor is further configured to execute the instructions to perform operations that convert data characterizing the selected next action to the output audio signal.

19. The system of claim 17, wherein the additional data comprises at least one of health information, insurance eligibility data, clinical authorization data, or medical record metadata associated with the recipient.

20. The system of claim 14, wherein the at least one processor is further configured to execute the instructions to train the artificial intelligence process using domain-specific conversational data associated with a particular conversational workflow.
